(19) United States
(12) Patent Application Publication
(10) Pub. No.: US 2013/0222857 A1
(43) Pub. Date: Aug. 29, 2013

(54) PRINTER CONTROL APPARATUS

(71) Applicant: Riso Kagaku Corporation, (US)

(72) Inventors: Kouichi NOBUSHIMA, Ibaraki-ken (JP); Masaki OZAWA, Ibaraki-ken (JP); Masatoshi ENOKITO, Ibaraki-ken (JP)

(73) Assignee: RISO KAGAKU CORPORATION, Tokyo (JP)

(21) Appl. No.: 13/775,642

(22) Filed: Feb. 25, 2013

(30) Foreign Application Priority Data
Feb. 28, 2012 (JP) 2012-041883

(51) Int. Cl. G06K 15/02

(52) U.S. Cl. CPC G06K 15/1848
USPC 358/1.18

(57) ABSTRACT

A printer control apparatus includes an individual processing unit configured to retrieve layout setting information and generate print data that defines a print layout of the page images, a coordinate data converter configured to generate revised coordinate data by converting coordinate data of a target area based on the layout setting information, a particular processing unit configured to execute a particular processing to the target area based on the revised coordinate data and the print data, and a print job output unit configured to output the print data processed by the particular processing to the printer as a print job. According to the printer control apparatus, a user can specify the target area easily and accurately. The revised coordinate data is stored together with the layout setting information, so that the revised coordinate data can be utilized when a printing processing with the identical print layout will be executed.

### BACKGROUND OF THE INVENTION

1. Technical Field

The present invention relates to a printer control apparatus that outputs a print job generated based on page images of an original document to a printer.

2. Background Art

Conventionally, known is a technique in which a print job including subsets is processed by executing an individual processing (finishing processing) for each of the subsets (or, for each of the preset number of subsets) when a print control apparatus (e.g. a client terminal) generates the print job based on page images of an original document and outputs the print job to a printer. Japanese Patent Application Laid-Open No. 2010-277245 discloses such a technique.

In the above-explained technique, the first page in a subset is set as a delimiter page and a finishing process is set with being associated with the delimiter page. Therefore, each processing (e.g. stapling, punching, face-up/down ejection and N-up page layout) can be executed individually for every subset even during a single print job.

### SUMMARY OF THE INVENTION

When printing a barcode by an inkjet printer which is commonly used recently, a particular processing may be processed in order to prevent degradation of barcode scanning accuracy due to bleed/dot-gain of ink (e.g. black bars should be printed with lower concentration than that of other black solid areas). Therefore, it is needed to specify an area(s) (e.g. a barcode area(s) in a page) to be processed by the particular processing.

For example, by using barcode area specifying application program, a user displays an image of a page in a print job on a screen based on original document data of the page and then specifies the barcode area on the screen. However, inconsistency may occur between the area specified based on the original document data of the page and an area treated with the above-explained lowered concentration after printing.

This is because the original document data may have various file formats generated by various application programs (e.g. a word processing application program, a spreadsheet application program and a PDF application program). The barcode area specifying application program may fail to decode the original document data precisely due to the various file formats, and thereby the above-explained inconsistency occurs.

On the other hand, print data (PRN data) which are generated from the original document data by a printer driver for a printer is PDL data (image data) inherently generated for the printer, so that the print data coincides with page images obtained by printing the original document data by the printer. Therefore, if a decoder module for decoding PDL data is implemented in software by which the original document data is generated, page images that coincide with print images can be generated based on print data (PRN data) and displayed on a screen regardless of various software. As a result, a barcode area can be specified precisely by using barcode area specifying application program based on the page images displayed on a screen.

In this case, page images are displayed in the same order as in an original document by using print data (PRN data) on a screen for specifying a barcode area(s). Subsequently, a user specifies a barcode area(s) and default CSV data in which the barcode area(s) is defined by a page number and a coordinate (a coordinate of an upper left point of the barcode area and vertical and horizontal lengths from the point) is generated. According to this method, the original document data including a barcode(s) can be printed correctly by using the above-explained CSV data even when the original document data is printed in a page order different from an original page order of the original document (e.g. a face-up ejection may need reverse-order printing).

However, in a case where an individual processing is an N-up page layout processing for printing multiple pages on a single page, a page layout (e.g. an arrangement of a barcode area(s) may be changed because multiple pages are to be printed on a single page. When a page layout is changed as mentioned above, the barcode area(s) cannot be set correctly based on a default CSV data generated based on a layout of original document data.

Similarly, in a case where a finishing processing is set per each subset explained above, a page order may change in print data (e.g. face-up ejection, printing for double-leaved booklet and so on), or an arrangement of a barcode area(s) on a page may change (above-explained N-up page layout and so on). For these cases, default CVS data in which a page order is the same as in the original document data cannot be generally used for the above functions without any additional processes. Therefore, processes for using the above functions may become complicated.

In addition, also in a case of obtaining the above-explained CSV data by specifying a target area in an original document for executing a certain processing to the target area, processes for the processing may become complicated similarly.

An object of the present invention is to provide a printer control apparatus that can easily and accurately specify a target area to be processed by a particular processing on print images even in a case a print layout on a print sheet is to be changed by an individual processing such as N-up page layout.

An aspect of the present invention provides a printer control apparatus that is configured to output a print job generated based on page images of an original document to a printer and includes: an original document data retriever configured to retrieve the page images ordered in a page order of the original document as original document data; an individual processing unit configured to retrieve layout setting information that defines a print layout of the page images to be printed on a print sheet by the printer based on an individual processing to be applied to the original document data, and to generate print data in which print images are ordered according to the layout setting information; a coordinate data storage unit configured to correlate coordinate data of a target area in the page images to be processed by a particular processing with the page order of the original document, and to store the coordinate data for each of the print images; a coordinate data converter configured to generate revised coordinate data by converting the coordinate data stored in the coordinate data storage unit based on the layout setting information; a particular processing unit configured to execute the particular processing to the target area based on the revised coordinate data and the print data; and a print job output unit configured to output the print data processed by the particular processing to the printer as the print job.

Here, original document data is referred as data generated by software (application program such as word processing application program, graphics application program) and including texts/images and so on. In addition, print data is referred as data encoded by software (printer driver) for sending print information (image information) of original document data to a printer. Further, an individual processing is referred as a finishing processing applied to original document data (e.g. stapling, punching, face-up/down ejection, N-up page layout and so on). The individual processing may include processes applied individually to each of subsets included in a single print job for printing plural pages.

According to the aspect, since the coordinate data having the page order of the original document is converted to the revised coordinate data optimized with the layout setting information, the page images can be printed adequately so as to comply with the layout setting information even when the printing processing accompanied by a layout change due to the individual processing (e.g. N-up page layout or the like) is executed.

According to the aspect, the target area to be processed by the particular processing can be specified easily and accurately even when the printing processing accompanied by a layout change due to the individual processing (e.g. N-up page layout or the like) is executed.

It is preferable that the coordinate data storage unit is configured to correlate the revised coordinate data with the layout setting information, and to store the revised coordinate data correlated with the layout setting information.

According to this configuration, since the revised coordinate data is stored with the layout setting information, the revised coordinate data can be utilized when a printing processing with the identical print layout will be executed.

It is preferable that the coordinate data converter is configured to generate the generate revised coordinate data by modifying a size, a shape or a position of the target area based on the layout setting information, and the individual processing unit is configured to modify a size, a shape or a position of images outside the target area.

According to this configuration, a size, a shape or a position of the target area is firstly determined when the layout setting information includes a process accompanied by a layout change (e.g. a print scale change: print images are scaled down due to an N-up processing). And then, a size, a shape or a position of print images outside the target area is modified according to the determined target area. Therefore, the target area can be printed adequately, and all the print images outside the target area can be printed on the print sheet.

It is preferable that the target area is a barcode area including a barcode, and the particular processing is a processing for setting lower concentration to the barcode than concentration of other colored solid portions in the page images. Note that a term “colored” is includes single-colored (e.g. monochrome) and multi-colored (e.g. polychrome).

According to this configuration, only the barcode area including the barcode is processed by the particular processing, so that degradation of barcode scanning accuracy due to ink bleed can be prevented and imaging accuracy of a whole print image can be ensured.

### BRIEF DESCRIPTION OF THE DRAWINGS

FIG. 1 is a block diagram showing a schematic configuration of a printer network system including a printer control apparatus(es) according to an embodiment;

FIG. 2 is a block diagram showing a barcode area specifying function module implemented in the printer control apparatus shown in FIG. 1;

FIG. 3A is an explanatory diagram for showing that print data is generated from original document data by a 2-up page layout processing;

FIG. 3B is an explanatory diagram for showing that coordinate data is revised for 2-up page layout printing;

FIG. 4 is an explanatory diagram for showing a particular processing for 2-up page layout printing;

FIG. 5A is an explanatory diagram for showing that print data is generated from original document data by a 2-up page layout processing;

FIG. 5B is an explanatory diagram for showing that coordinate data is revised for 2-up page layout printing;

FIG. 6 is an explanatory diagram for showing a particular processing for 2-up page layout printing;

FIG. 7A is an explanatory diagram for showing that print data is generated from original document data by a margining processing;

FIG. 7B is an explanatory diagram for showing that coordinate data is revised for margining printing;

FIG. 8 is an explanatory diagram for showing a particular processing for margining printing;

FIG. 9A is an explanatory diagram for showing job data generated by the printer driver shown in FIG. 2;

FIG. 9B is also an explanatory diagram for showing job data generated by the printer driver shown in FIG. 2;

FIG. 10A is a diagram for showing a page order in original document data;

FIG. 10B is a diagram for showing a page order in print data;

FIG. 10C is a diagram for showing a page order displayed by a barcode area specifying application program;

FIG. 10D is a diagram for showing a page order in CSV data;

FIG. 11 is a perspective view of a double-leaved booklet;

FIG. 12 is a flowchart of processes for revising coordinate data; and

FIG. 13 is a flowchart of processes for generating coordinate data.

### DESCRIPTION OF THE EMBODIMENTS

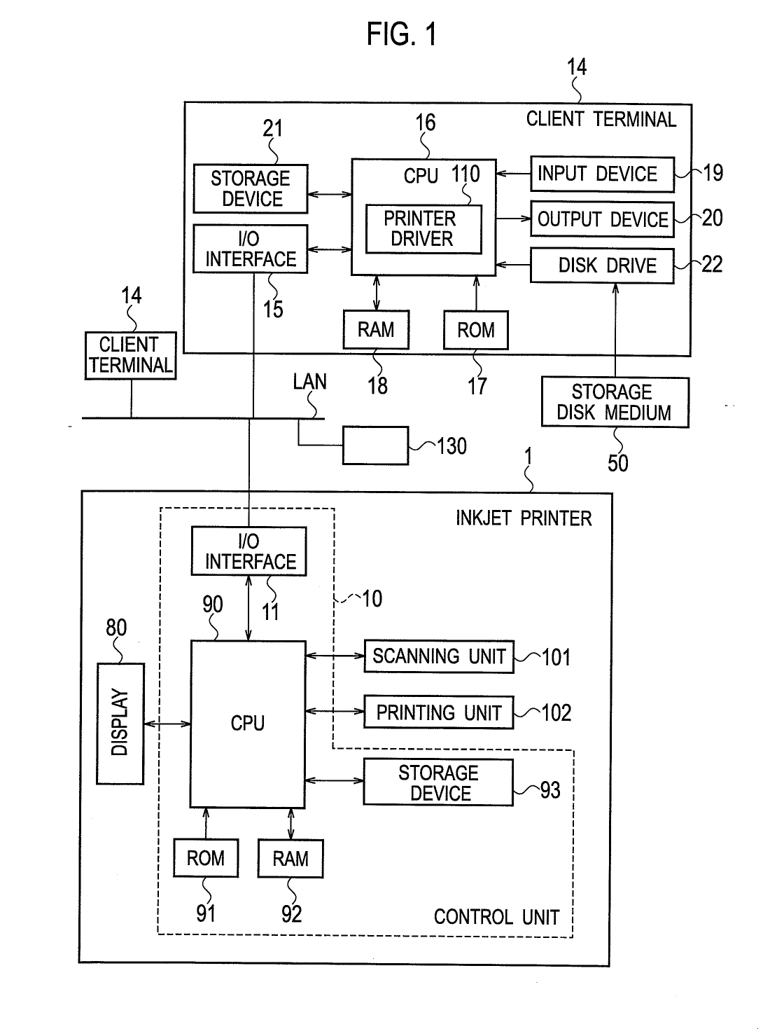

Hereinafter, embodiments will be explained with reference to the diagrams. An inkjet printer 1 shown in FIG. 1 is a color printer. The inkjet printer 1 includes multiple ink heads on each of which many nozzles are formed, and executes printing by injecting black and color inks from the ink heads to form an image on a print sheet on a feed belt.

(Overall Configuration of Printer Network System)

As shown in FIG. 1, a printer network system includes the inkjet printer (served as a printer in claims 1 and client terminals (each served as a printer control apparatus in claims 14.

The inkjet printer 1 includes a scanning unit 101, a printing unit 102 and a control unit 10. The scanning unit 101 retrieves image information of a document as print images (or, page image) and output the image information as an image signal. The printing unit 102 prints (records) the print image on a print sheet (single-side or double-side) based on the image signal from the scanning unit 101. The control unit 10 controls the inkjet printer 1 holistically. Print sheets used in the printing unit 102 for printing a print image are fed from a sheet supply unit (not shown) to a sheet ejection unit (not shown) via the printing unit 102.

As shown in FIG. 1, I/O interfaces 15 of the client terminals 14 are connected with an I/O interface 11 of the control unit 10 via a local area network LAN (only one of the client terminals 14 is shown in detail in FIG. 1). The control unit 10 receives a print job(s) of print images from the client terminals 14. The control unit 10 generates raster data of the print images from the received print job. The inkjet printer 1 prints the print images on a print sheet(s) using the printing unit 102 according to a print setting set in the print job.

In addition, a display 80 is connected with the control unit 10. The display 80 is arranged at an upper portion of the inkjet printer 1. The display 80 can be utilized as an input device into which a user input a print/copy setting such as the number of print/copy runs, print/copy scaling rate and so on when printing/copying a print image of an original document set at the scanning unit 101.

The control unit 10 that controls the above-mentioned printing unit 102 to carry out printing operations includes a CPU 90 as shown in FIG. 1. The CPU 90 controls operations of the scanning unit 101 and the printing unit 102 according to settings input via the display 80 based on control programs and setting information that are stored in a ROM 91 or a storage device 93.

Note that the control unit 10 is also provided with a RAM 92, and a print job(s) input into the control unit 10 from the client terminals 14, various settings (e.g. the number of print/copy runs) input via the display 80 and so on are stored in the RAM 92 as needed.

In addition, a frame memory area is prepared in the RAM 92. Raster data of an print image generated by the CPU 90 from a print job input into the control unit 10 from the client terminals 14 is temporarily stored in the frame memory area until it is output to the printing unit 102.

Further, the control unit 10 is also provided with the storage device 93 such as a hard disk drive, and the storage device 93 is connected with the CPU 90. In the storage device 93, plural storage areas are provided for storing a print job(s) transmitted from the above-mentioned RAM 92. In addition, various tables, various counter values and so on are also stored in the storage device 93. For example, one of the tables stored in the storage device 93 may be a history data table.

The history data table is a table in which change histories of print settings are recorded for each of the print jobs stored in the RAM 92 or the storage device 93. For example, histories of print setting configurations (e.g. a printable area of a print sheet (adjustment of an image position), a target sheet tray from which a print sheet is fed out, print concentration and so on) are managed by the history table. These contents of the history table are periodically updated by a control of the CPU 90.

On the other hand, each of the client terminals 14 is configured of a personal computer or the like. The client terminal 14 includes a CPU 16 that executes carious processings based on control programs stored in a ROM 17 or a storage device 21. In addition, the CPU 16 is connected with a RAM 18, an input device 19 such as a keyboard and a mouse, an output device 20 such as an LCD, the storage device 21 such as a HDD and a disk drive 22 such as an optical/magnetic disk drive. The RAM 18 functions as a working area.

The storage device 21 includes an area for storing application programs which generates original document data including a print image(s) such as texts/images, an area for storing a printer driver for the inkjet printer 1, and an area for storing other various application programs. In addition, the storage device 21 also includes an area for storing original document data generated by the application programs and a database area for storing print data (e.g. PRN data). The print data is generated by encoding a print image of original document data into image data for printing according to print setting information.

Here, the print setting information is information needed for printing, such as a print mode, a size of original document data, a print resolution, a page size, a print orientation and so on. In addition, the print setting information also includes finishing setting information to be applied to original document data (e.g. information concerning stapling, punching, face-up/down ejection, margining, booklet printing, tiling printing, print scaling, N-up page layout and so on) concerning a finishing processing (served as an individual processing defined in Claims). The finishing setting information further includes information about subsets divided from print images of plural pages and information to be applied to each of the subsets.

In the present embodiment, the storage device 21 stores an application program for generating forms. The CPU 16 retrieves the application program and then executes it to generate forms (e.g. bills, purchase application forms and packaging lists, which are issued-for or sent-to each destination). Each of the forms may include a barcode(s).

The CPU 16 is a computing device configured of a processor, a memory chip(s) and other components, and run an application program(s) stored in the storage device 21 according to a request command(s) input from the input device 19. In addition, the CPU 16 generates original document data indicating images specified by parameters input via the input device 19 on the application program(s). The generated original document data are displayed on the output device 20, and stored in the database area in the storage device 21 if a “save” command is input by the input device 19.

The original document data stored in the database area in the storage device 21 is retrieved from the storage device 21 when an “open” command is input via the input device 19 during the application program is running. A print image(s) of the retrieved original document data can be output to the output device 20, and can be modified into a new original document data on the application program.

The CPU 16 virtually implements a printer driver 110 on its own by executing printer driver software when a “print” request for the original document data generated by an application program for generating a form or an original document. Then, a print job(s) is output to the inkjet printer 1 by the printer driver 110.

The printer driver 110 is data conversion software to be executed on the client terminal 14 in order to control the inkjet printer 1 connected with the client terminal 14. The printer driver 110 retrieves the original document data including a print image(s) generated by an application program for generating an original document, and then generated print data (PRN data) based on print setting information. Then, the generated print job is output from the I/O interface 15 (served as a print job output unit in Claims) of the client terminal 14 to the I/O interface 11 of the control unit 10 in the inkjet printer 1.

Here, explained will be a case where an application program generates original document data including a print image(s) of a form(s) that contains a barcode(s). When printing the original document data by the inkjet printer 1, it is important to prevent degradation of barcode scanning accuracy caused by width change of space bars (white portions between black bars) due to ink bleed of colored bar (solid black portions). Therefore, in order to ensure high barcode scanning accuracy, it is effective to print the colored bars with lower concentration than that of other colored solid portions in order to prevent ink bleed. However, colored bars must be printed with concentration more than minimum concentration that can be scanned.

Therefore, the CPU 16 in the present embodiment applies a particular processing for lowering concentration of a barcode(s) to print data when it generates a print job for printing form images (served as page images defined in claims). In order to apply the particular processing to the print data, it is needed to specify a barcode area(s) in each of pages (coordinate(s) on each of print sheets).

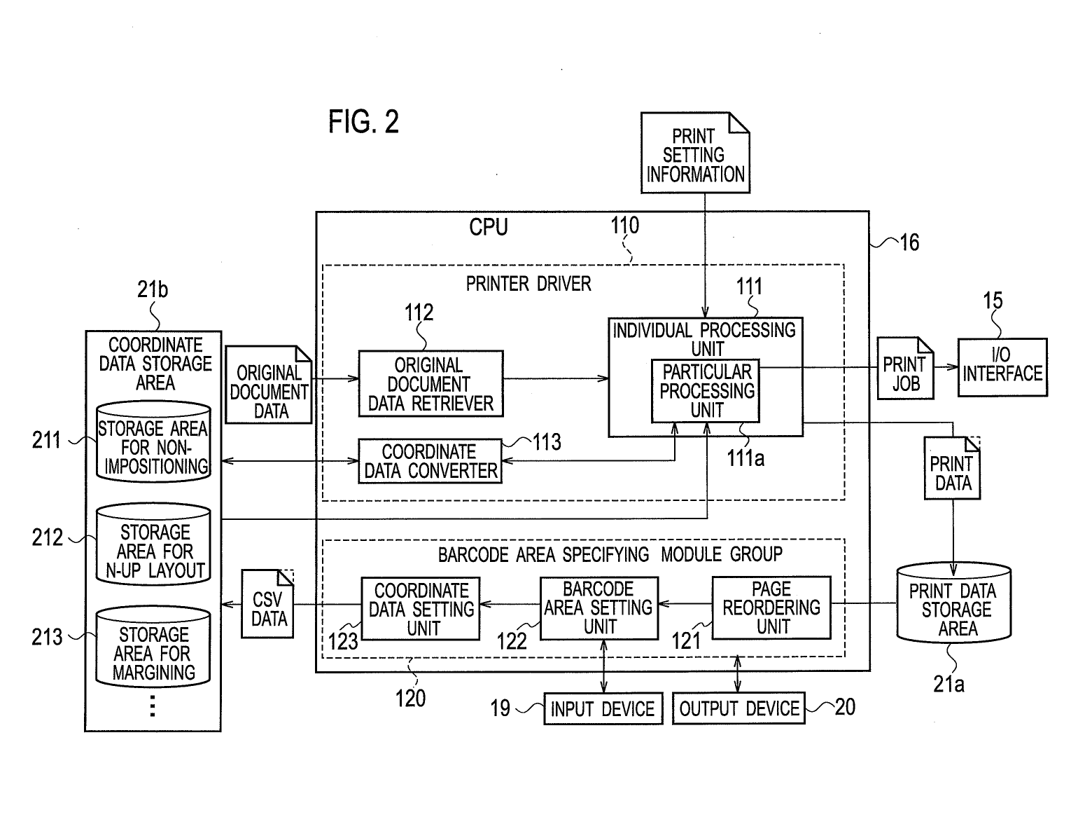

A barcode area specifying application program used for specifying an area(s) in which a barcode(s) is arranged (served as a target area in Claims) in print data is stored in the storage device 21. The barcode area specifying application program is run and executed on the CPU 16. The barcode area specifying application program generates print data (PRN data) of original document data by using the printer driver 110 when the original document data including a barcode area(s) to be specified is selected. Print images of pages in the generated print data is displayed on the output device 20, and a barcode area(s) are specified on the output device 20. A coordinate(s) of the specified barcode area(s) is generated for every page, and stored in a coordinate data storage area (coordinate data storage unit) 21b of the storage device 21 shown in FIG. 2 as after-explained coordinate data (CSV data). Here, the coordinate data storage area 21b of the storage device 21 is served as the coordinate data storage unit in Claims.

The coordinate data that indexes the barcode area(s) in the print images is generated by executing the barcode area specifying application program. The coordinate data of the barcode area(s) are CSV data, and page sizes to be used for printing and a coordinate(s) of the barcode area(s) are defined in the CSV data for each page including a barcode(s). A coordinate value of each barcode area is defined with a coordinate position of an upper-left reference point of a barcode area and width and height from the reference point of the barcode area. The width length is defined horizontally from the reference point to the right. The height length is defined vertically downward from the reference point. The coordinate value includes X and Y coordinates of the reference point and a width W and a height H of the barcode area.

Especially in the present embodiment, page numbers of pages including the barcode areas defined in the coordinate data are made coincided with page numbers of the original document defined in the original document data. Note that, in the coordinate data, the coordinate value may be defined by dimensional values (e.g. mm) or pixel values from an upper left corner of a page according to a page size.

The coordinate value is stored/saved in the storage device 21 as a barcode area specifying file with an input file name when a “save” operation is made by the input device 19 such as a mouse (e.g. a “save as . . . ” command is selected from a menu, and then the file name is input). Then, the CPU 16 executes the particular processing to the barcode area by using the barcode area specifying file when receiving a print request.

Since the coordinate data indexes a coordinate position(s) of the barcode(s) in each page, a coordinate position of a barcode area may become unmatched with a coordinate value in an actual print image after a finishing processing that inevitably needs a print layout change (e.g. multiple pages are printed on a single page such as an N-up page layout processing).

Therefore, in the present embodiment, coordinate data after an inevitable print layout change caused by a finishing processing such as explained above are generated based on the coordinate data stored in the storage device 21. The newly generated coordinate data become matched with the changed print layout. Hereinafter, cases will be explained, in each of which coordinate data are revised (newly generated) for an inevitable print layout change due to a finishing processing.

(A) N-up Page Layout Processing without Scale Change of Print Images

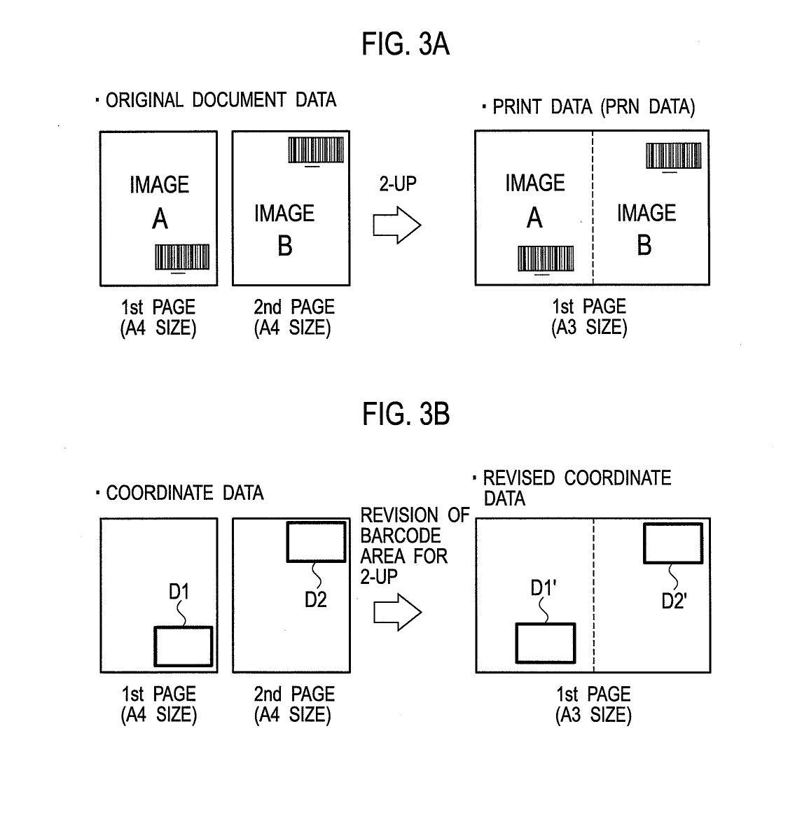

Note that, in this case, two A4 size pages are printed on one A3 size print paper, so that scale of print images is not changed. As show in FIG. 3A, print data (PRN data) for one page (A3 size) is generated by imposing the first and second pages (A4 size) of original document data based on a 2-up page layout setting.

As shown in FIG. 3B, the CPU 16 generates revised coordinate data D1′ and D2′ to be merged with the print data (PRN data) by converting coordinate values of coordinate data D1 and D2 for the first and second pages (A4 size) of the original document data according to layout information for the 2-up page layout. Here, the CPU 16 retrieves the coordinate data D1 and D2 from the coordinate data storage area 21b of the storage device 21.

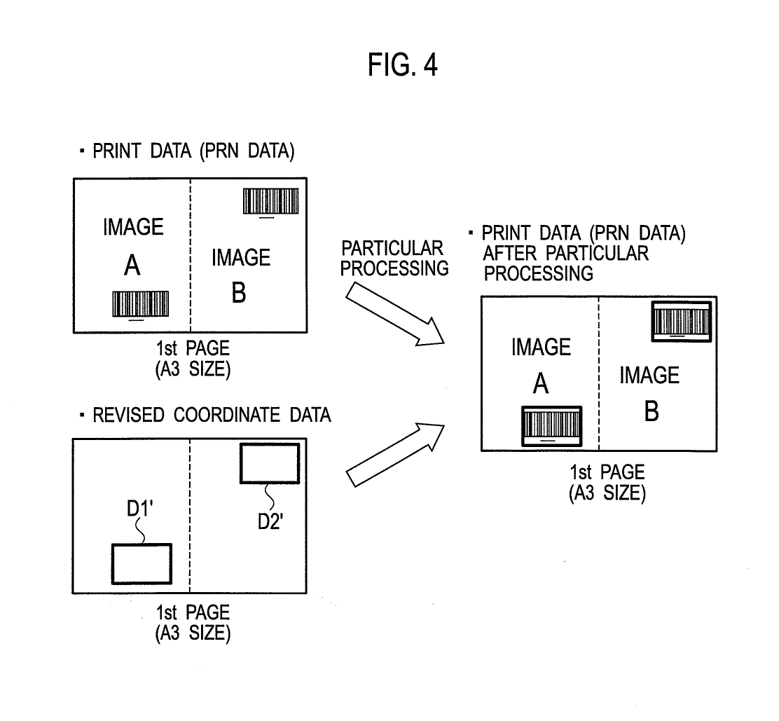

As shown in FIG. 4, the CPU 16 merges the revised coordinate data D1′ and D2′ with the print data (PRN data: A3 size including the 2-up layout), and executes a particular processing to set reduced print concentration to the barcodes in the barcodes areas defined by the revised coordinate data D1′ and D2′.

(B) N-up Page Layout Processing with Scale Change of Print Images

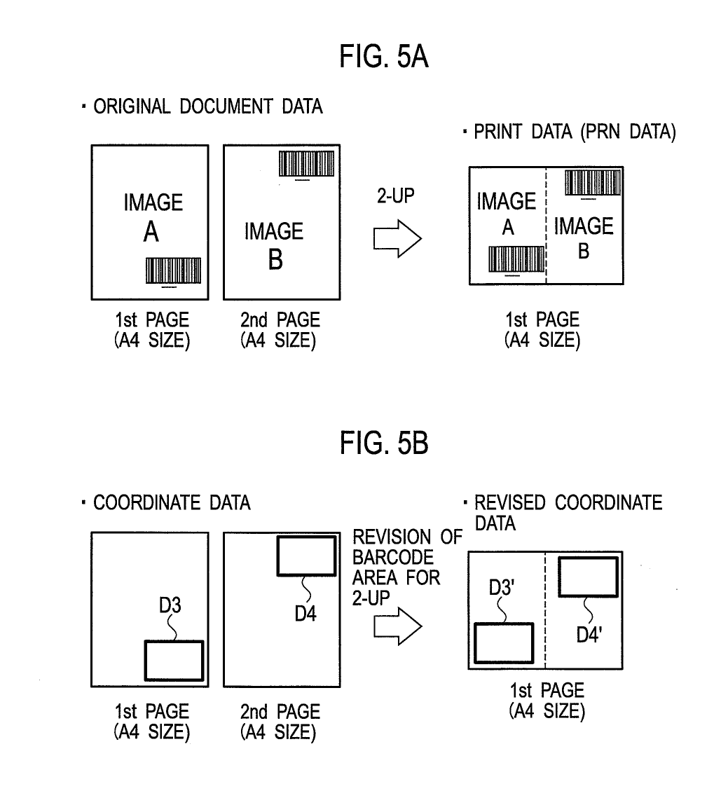

Note that, in this case, two A4 size pages are printed on one A4 size print paper, so that scale of print images is changed. As show in FIG. 5A, print data (PRN data) for one page (A3 size) is generated by imposing the first and second pages (A4 size) of original document data based on a 2-up page layout setting, and then the generated print image for the one page (A3 size) is reduced to generated print data (PRN data) for one page (A4 size).

As shown in FIG. 5B, the CPU 16 generates revised coordinate data D3′ and D4′ to be merged with the print data (PRN data) by converting coordinate values of coordinate data D3 and D4 for the first and second pages (A4 size) of the original document data according to layout information for the 2-up page layout. Here, the CPU 16 retrieves the coordinate data D3 and D4 from the coordinate data storage area 21b of the storage device 21.

Note that the CPU 16 generates the revised coordinate data D3′ and D4′ according to a size, a shape or a position of the reduced barcode area in a case where the reduced barcode has a dimension enough to be scanned correctly, but generates the revised coordinate data D3′ and D4′ based on a size, a shape or a position of a barcode modified so as to be scanned correctly in a case where the reduced barcode doesn't have a dimension enough to be scanned correctly.

In such a case of a 2-up page layout processing to print two A4 size pages on one A4 size print sheet, a dimension of the modified barcode area to be scanned correctly is set to a dimension more than twice the dimension of the reduced barcode area according to a default reduction scale rate for the 2-up page layout. Here, if the reduced barcode area doesn't have a dimension enough to be scanned correctly, the dimension of the barcode area is not reduced and only its coordinate position is modified to generate the revised coordinate data D3′ and D4′.

Namely, the size of the barcode area is not reduced (an original size of the barcode area is maintained) when reducing one A3 page including two A4 page into one A4 page in order to make the barcode scanned correctly. Then, remaining reduced images other than the barcode are arranged outside the maintained barcode area. Therefore, the size of the barcode areas by the revised coordinate data D3′ and D4′ are not changed after the N-up page layout processing, and only the positions of the barcode areas are changed.

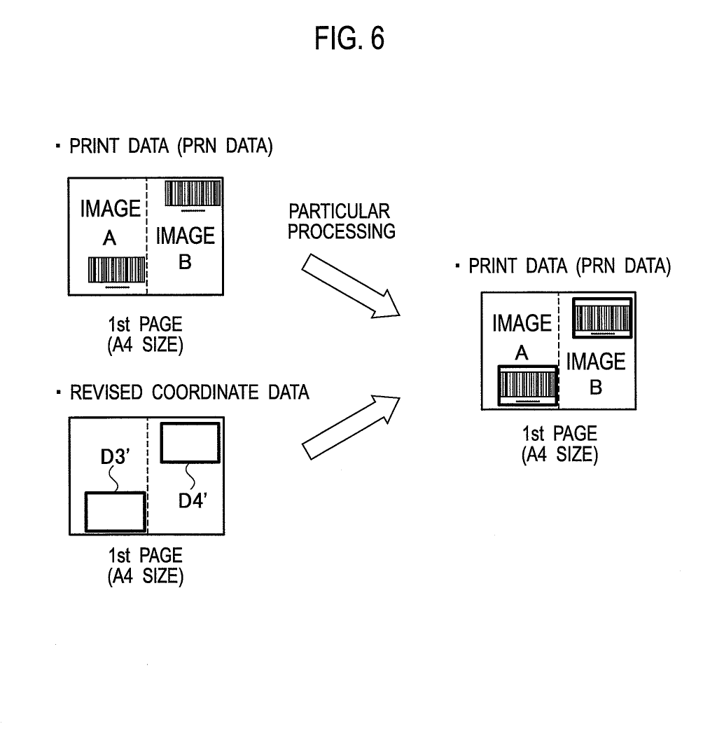

Then, as shown in FIG. 6, the CPU 16 merges the revised coordinate data D3′ and D4′ with the print data (PRN data: A4 size including the 2-up layout), and executes a particular processing to set reduced print concentration to the barcodes in the barcodes areas defined by the revised coordinate data D3′ and D4′.

Namely, the CPU 16 modifies a size, a shape or a position of a barcode print image(s) within the barcode area(s) based on the revised coordinate data D3′ and D4′, and also modifies a size, a shape or a position of all images (images A and B) other than the barcode(s) outside the barcode area(s).

(C) Margining Processing without Scale Change of Print Images

Note that, in this case, a margin is added at one side of the original document data and a print area is simply shifted parallel without scale change of print images.

In this case, the CPU 16 shifts a coordinate position of the upper-left reference point of the barcode area(s) according to a width of the added margin, and the coordinate value of the barcode area (that includes X and Y coordinates of the reference point and a width W and a height H of the barcode area) is changed according to the shifted amount of the reference point. In addition, the CPU 16 shifts a position of all images other than the barcode outside the barcode area. Note that, since the pint image is shifted parallel only to the right in this case, only the Y coordinate may be changed. In this case, the revised coordinate data is generated as explained above.

(D) Margining Processing with Scale Change of Print Images

Note that, in this case, a margin is added at one side an upper and lower ends of the original document data, and a print image is reduced because the print image cannot be fit in a print sheet with the same size as that of the original document data.

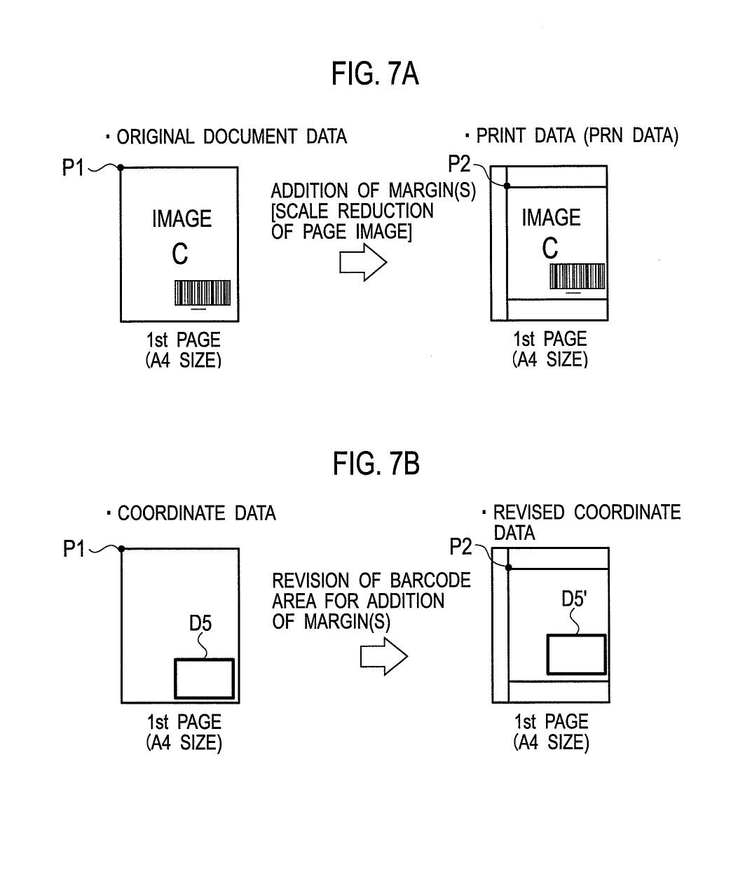

In this case, as shown in FIG. 7A, the CPU 16 reduces a whole print image according to margins in order to fit the print image in a print page to generate print data (PRN) data. Namely, the CPU 16 reduces and shifts a print image according to margins, and calculates a shifted amount from an original upper-left point P1 of the print image to a shifted upper-left point P2 along X and Y coordinate axes. In addition, as shown in FIG. 7B, the CPU 16 also shifts a coordinate position of the upper-left reference point of the barcode area(s) according to the shifted amount, and the coordinate value of the barcode area (that includes X and Y coordinates of the reference point and a width W and a height H of the barcode area) is changed according to the shifted amount. In this case, the coordinate data D5 is converted to the revised coordinate data D5′ as explained above.

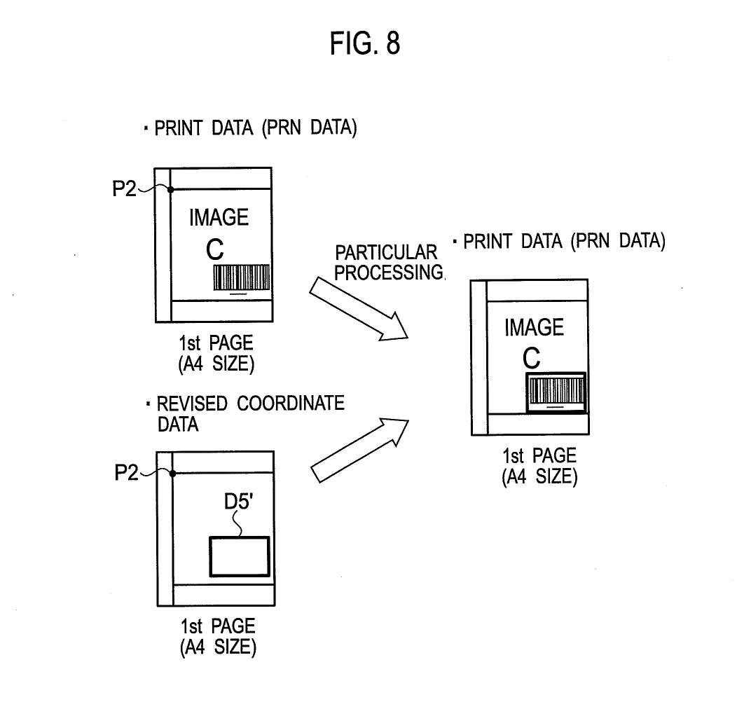

Then, as shown in FIG. 8, the CPU 16 merges the revised coordinate data D5′ with the print data (PRN data), and executes a particular processing to set reduced print concentration to the barcodes in the barcodes areas defined by the revised coordinate data D5′.

Note that, also in this case, the CPU 16 generates the revised coordinate data D5′ according to a size, a shape or a position of the reduced barcode area in a case where the reduced barcode has a size enough to be scanned correctly, but generates the revised coordinate data D5′ based on a size, a shape or a position of a barcode modified so as to be scanned correctly in a case where the reduced barcode doesn't have a size enough to be scanned correctly. Namely, the CPU 16 modifies a size, a shape or a position of a barcode print image(s) within the barcode area(s) based on the revised coordinate data D5′ so as to be scanned correctly and also modifies a size, a shape or a position of all images (image C) other than the barcode(s) outside the barcode area(s) so as to be fit in a print sheet.

(Constitutions on CPU)

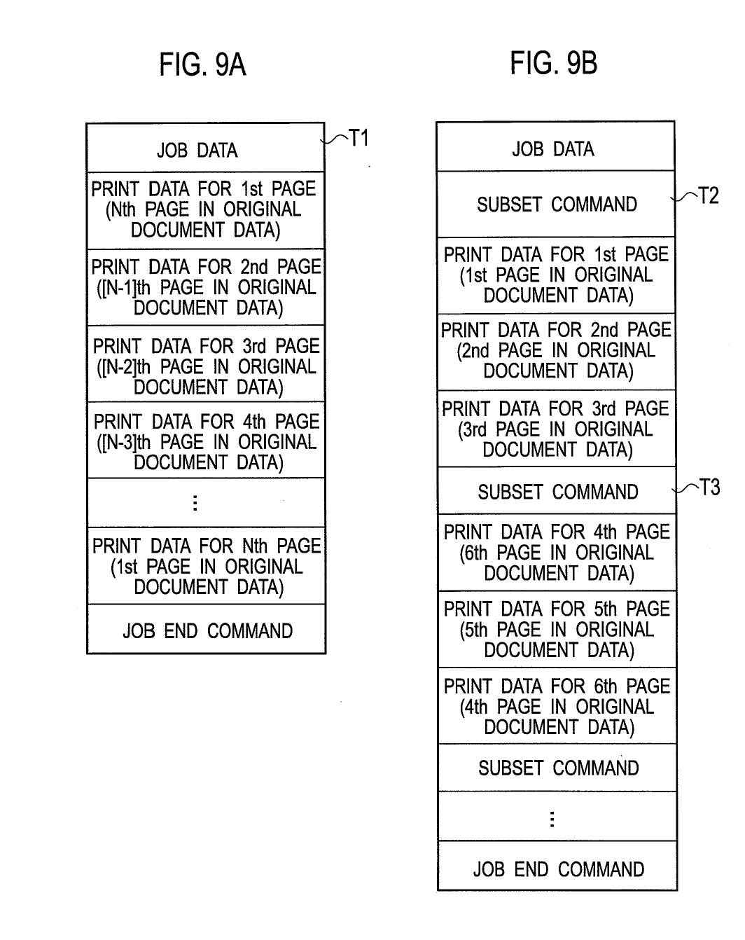

Next, internal constitutive blocks implemented on the CPU 16 for executing the above operations will be explained with reference to FIGS. 2, 9A and 9B. Note that a term “module” used here is configured by hardware such as an apparatus and a device, software that functions equally to the hardware, or a combination of hardware and software, and the module is a functional unit for achieving a desired operation.

As shown in FIG. 2, the printer driver 110 is virtually implemented on the CPU 16 by executing the printer driver software, and a barcode area specifying module group 120 is also virtually implemented on the CPU 16 by executing the barcode area specifying application program.

(1) Constitutions of Printer Driver 110

The printer driver 110 includes an original document data retriever 112 and an individual processing unit 111. The original document data retriever 112 is a module for retrieving original document data when a print request for a print image(s) of the original document data is input. The original document data retriever 112 retrieves, as the original document data, page images in a page order of an original document created by an application program such as a word processing application program.

The individual processing unit 111 is a module for generating print data that is converted, as image data, from a print image(s) of the original data based on print setting information input by a user's operation or the like. Especially when print setting information includes finishing setting information, the individual processing unit 111 retrieves layout setting information according to the finishing setting information. Note that the layout setting information includes information about page layouts of print images to be printed and information about a print order of the print image. Then, the individual processing unit 111 generates print data according to the layout setting information.

For example, when a face-up ejection for a single print job is set in print setting information as finishing setting information, information (a print command) for printing pages reversely (descending order) to the page order (ascending order) of the original document data is generated as setting information (hereinafter, referred as order information) with respect to a print order by the inkjet printer 1, and then the order information is stored at a job header T1 of a print job (see FIGS. 9A).

Then, the individual processing unit 111 assign a print image of the Nth page of the original document data to the first page of the print data according to the print command (descending order) as shown in FIG. 9A. Similarly, a print image of the [N-1]th page of the original document data is assigned to the second page of the print data, and a print image of the [N-2]th page of the original document data is assigned to the third page of the print data. Remaining print images are assigned similarly, so that a print image of the first page of the original document data is assigned to the Nth page of the print data. In this manner, the individual processing unit 111 generates the print data including a print order set by reversely reordering the page order of the original document data.

Alternatively, when finishing setting information for subsets in a single print job is set in print setting information, order information is generated per each of the subsets, and the page order of the original document data is reordered according to each subset command. For example, as shown in FIG. 9B, when a face-down ejection is set to the first to third pages of the original document data as a subset finishing processing, generated is order information for printing the first to third pages in the same order (ascend order) as the page order of the original document data. This order information is stored at the subset command T2 for the first to third pages of the print data.

In addition, when a face-up ejection is set to the fourth to sixth pages of the original document data as a subset finishing processing, generated is order information for printing the fourth to sixth pages in a reverse order (descend order) to the page order of the original document data. This order information is stored at the subset command T3 for the fourth to sixth pages of the print data.

According to the subset command T2 (face-down ejection), an print image of the first page of the original document data is assigned to the first page of the print data, an print image of the second page of the original document data is assigned to the second page of the print data, and an print image of the third page of the original document data is assigned to the third page of the print data.

In addition, according to the subset command T3 (face-up ejection), an print image of the sixth page of the original document data is assigned to the fourth page of the print data, an print image of the fifth page of the original document data is assigned to the fifth page of the print data, and an print image of the fourth page of the original document data is assigned to the sixth page of the print data. In this manner, the print data for the single print job is generated to include a print order different from the page order of the original document data.

In addition, the individual processing unit 111 includes a particular processing unit 111a. The particular processing unit 111a is a module for executing a particular processing with a print image(s) of the print data generated by the individual processing unit 111. Here, the particular processing unit 111a selects coordinate data or revised coordinate data for specifying a barcode area(s) in the print image(s) in order to execute the particular processing. Specifically, the particular processing unit 111a refers to the layout setting information of the original document data for which the print request is generated, and judges whether or not coordinate data corresponding to the layout setting information is stored in the coordinate data storage area 21b.

When coordinate data corresponding to the layout setting information is stored, the particular processing unit 111a executes the particular processing with the print image(s) of the print data by merging the coordinate data with the print data (PRN data) whose page layout is revised. On the other hand, when coordinate data corresponding to the layout setting information is not stored, a coordinate data converter 113 is controlled to generate revised coordinate data according to new layout setting information. Then, the particular processing unit 111a retrieves the revised coordinate data generated by the coordinate data converter 113, and executes the particular processing with the print data revised according to the new layout setting information.

The particular processing is a processing for setting concentration of colored bars in a barcode area(s) corresponding to the coordinate data (CSV data) lower than that of other colored solid portion.

Specifically, printing with the lower concentration of the colored bars of a barcode(s) can be achieved by reducing dot amount for pixels of the colored bars. For example, in a case where a solid black area is printed by composite black printing using not only K (black) ink but also C (cyan), M (magenta) and Y (yellow) inks, the colored bars of a barcode(s) is printed by pure black printing using only K (black) ink (without using C (cyan), M (magenta) and Y (yellow) inks). Then, the print data after the particular processing are output to the inkjet printer 1 via the individual processing unit 111 as a print job adapted to the layout setting information.

In addition, the particular processing unit 111a modifies a size, a shape or a position of the barcode area(s) in the print image(s) according to the barcode area(s) of the revised coordinate data. Further, the particular processing unit 111a also executes processing for modifying a size, a shape or a position of the print image(s) included outside the barcode area(s) so that a whole page image can be printed on a print sheet.

The coordinate data converter 113 is a module for converting the coordinate data stored in the coordinate data storage area 21b to the revised coordinate data in which a size, a shape or a position of barcode(s) (barcode area(s)) are revised based on the new layout setting information. The revised coordinate data generated by the coordinate data converter 113 are coordinate data optimized for print data in which a page layout(s) is modified according to the particular processing such as N-up page layout and booklet printing. The revised coordinate data generated by the coordinate data converter 113 are generated according to the layout setting information as explained in the above (A) to (D).

Note that the revised coordinate data generated by the coordinate data converter 113 are correlated with the layout setting information, and stored in database prepared for each page layout (e.g. stored in a storage area for N-up 212 when the layout setting information includes a layout(s) for N-up, or stored in a storage area for margining 213 when the layout setting information includes a layout(s) for margining).

(2) Constitution of Barcode Area Specifying Module Group 120

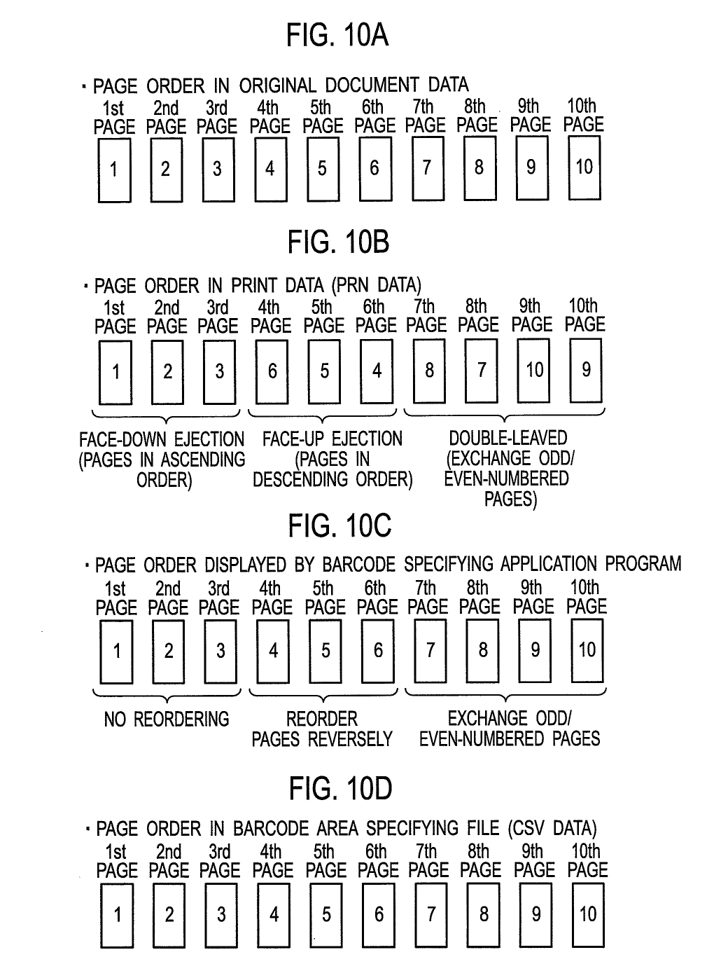

The barcode area specifying module group 120 will be explained with reference to FIGS. 10A to 10D. Note that numerals indicated in pages are page numbers of the original document data.

The barcode area specifying module group 120 is a module group for generating coordinate data be used by the coordinate data converter 113 to generate revised coordinate data. The barcode area specifying module group 120 uses print data initially generated by a print request, but generates, even when the print data includes a page order (see FIG. 10B) different from a page order (See FIG. 10A) of original document data, coordinate data with a page order of original document data by reordering the different page order of the print data.

The barcode area specifying module group 120 includes a page reordering unit 121, a barcode area setting unit 122 and a coordinate data setting unit 123. The page reordering unit 121 is a module that retrieves, from the print data storage area 21a, print data that includes a barcode area(s) to be set, and displays page images in a page order (see FIG. 10C) of original document data after reordering a print order (see FIG. 10B) of the retrieved print data with reference to page order information stored in the retrieved print data.

Specifically, in a state where the barcode area specifying application program is being executed, the page reordering unit 121 displays, on the display (output device 20), a list of document files of forms each including a barcode area(s) to be specified when a user selects an “open file” menu on a display screen. When a document file including a barcode(s) to be specified is selected from the list, print data corresponding to the selected document file is retrieved from the print data storage area 21a.

Then, the page reordering unit 121 reorders the print order (see FIG. 10B) of the print data to the page order (see FIG. 10A) of original document data based on the page order information stored in the retrieved print data. For example, if a finishing processing is set for each subset in a print job as shown in FIG. 10B, the page reordering unit 121 firstly reads out layout setting information for each subset from the print data.

Subsequently, the page reordering unit 121 reorders, for each subset, the print order of the print data to an order identical to the page order of original document data. As a result, as shown in FIGS. 10B and 10C, the first to third pages are ordered in an ascending order identical to the first to third pages of the original document data. This subset is to be printed by a face-down ejection to have a print order identical to the page order of the original document data.

The fourth to sixth pages are reversely reordered by exchanging the sixth page with the fourth page. Namely, the fourth to sixth pages are reordered in an ascending order from a descending order of the print data by exchanging the sixth page with the fourth page. This subset is to be printed by a face-up ejection to have a print order that is reversal to the page order of the original document data.

The fourth to sixth pages are reordered by exchanging an odd-numbered page with an even-numbered page in each pair of two pages. Namely, the seventh to tenth pages are reordered in an ascending order by exchanging the eighth page with the seventh page and exchanging the tenth page with the ninth page. This subset is to be printed by double leaved booklet printing to have a print order different from the page order of the original document data.

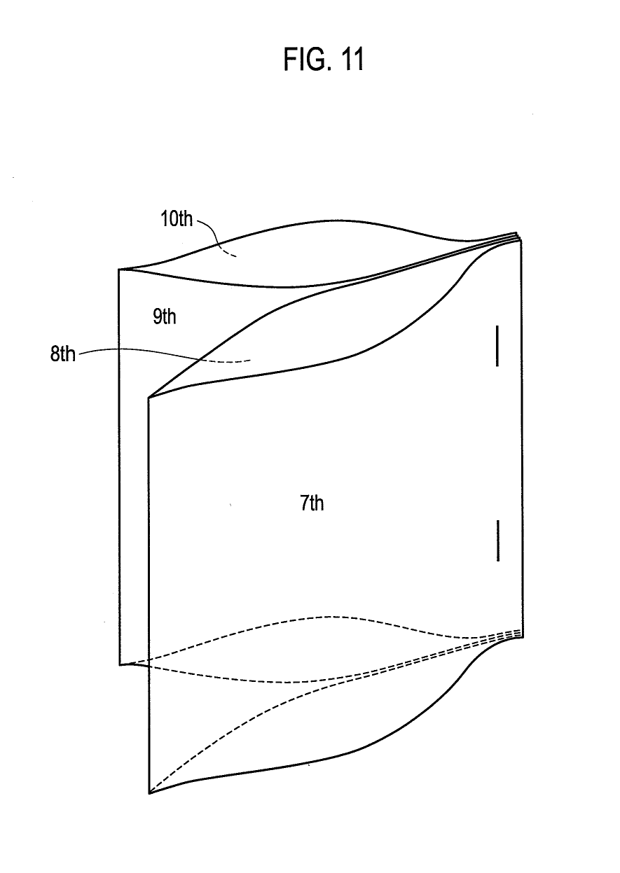

By the double leaved booklet printing, the seventh to tenth pages are printed as shown in FIG. 10B. The seventh and eighth pages are printed on one side of a print sheet, and the ninth and tenth pages are printed on one side of another sheet. And then, each of the two sheets are folded and stapled together as shown in FIG. 11. Note that pages of this booklet are flipped to the right to proceed (books with a vertical text direction often have this style in Japan).

Then, the page reordering unit 121 displays the print data on the output device 20 in the reordered page order identical to that of the original document data as an edit screen for specifying a barcode area(s) as shown in FIG. 10C. Note that, even when print data processed by an N-up page layout processing is stored in the print data storage area 21a, page images before the N-up page layout processing are displayed on the output device 20 page by page according to order information.

The barcode area setting unit 122 is a module for receiving a direction(s) for specifying a barcode area(s) to be processed by a particular processing. The direction for specifying the barcode area to be processed is input by a user's input operation on the edit screen displayed on the output device 20 using the input device 19 such as a mouse. Specifically, the barcode area is set by a drag operation of a mouse pointer on the page images displayed on the edit screen, for example.

The specified area is displayed as an area image on the edit screen. The area image may be a frame indicating an outline of the area or a dotted pattern with in the area. Through this specifying operation, a coordinate value of the specified barcode area on the page can be retrieved. In addition, the retrieved coordinate value of the barcode area is stored in the coordinate data storage area 21b of the storage device 21 with a file name input by a user's operation (e.g. a “save as . . . ” command is selected from a menu, and then the file name is input).

The coordinate data setting unit 123 is a module for setting the barcode area(s) indicated by the user's direction for specifying the barcode area(s). Specifically, when the operation for saving the coordinate value of the barcode area(s) is made, the coordinate data sets the coordinate data so as to associate it with the page numbers ordered in the page order of the original document as shown in FIG. 10D. Then, the coordinate data setting unit 123 stores the associated coordinate data in a storage area for non-impositioning 211 of the storage device 21 with a file name that is input by a user.

The printer driver and various application programs for executing above-mentioned processings by the CPU 16 can be installed (stored) in the storage device 21 from a storage disk medium 50 such as an optical disk by use of the disk drive 22 of the client terminal 14.

(Processes for Generating Revised Coordinate Data)

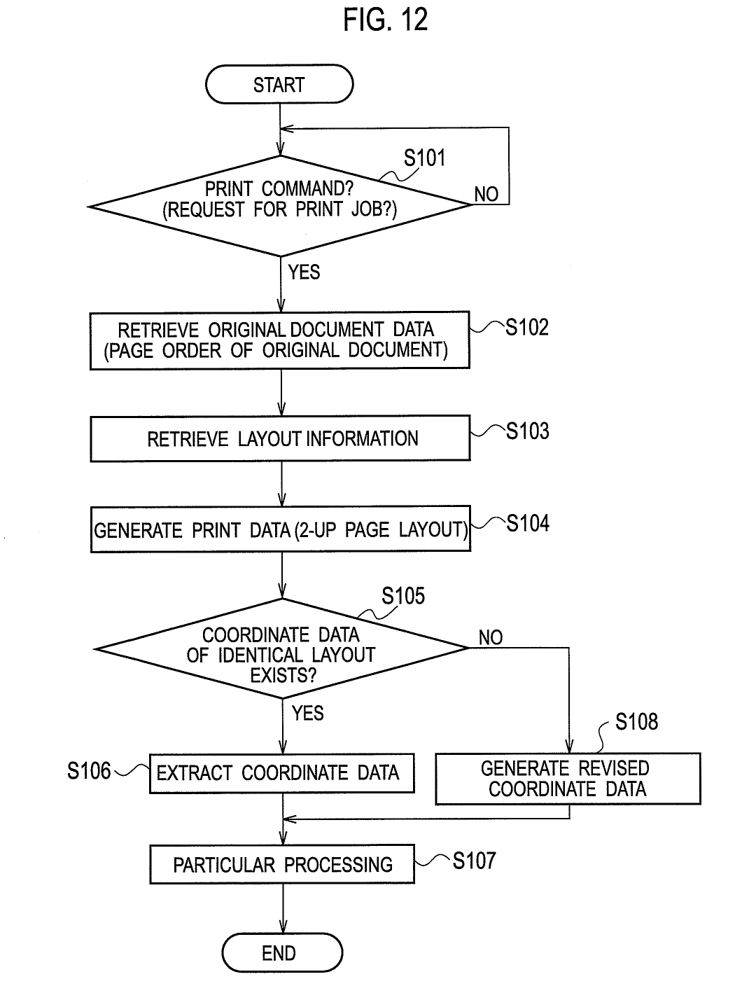

Processes for generating revised coordinate data executed by the CPU 16 of the client terminal 14 will be explained with reference to a flowchart shown in FIG. 12. Note that, in the present embodiment, explained will be an exemplary case where a print request for a 2-up page layout is made. By the 2-up page layout, two A4-size pages will be printed on one A4-size print sheet.

Firstly, the printer driver 110 judges whether or not a print request for a displayed document is made during an application program is running (step S101). If the print request is not made (NO in step S101), it stands by until the print request is made. If the print request is made (YES in step S101), it retrieves print images ordered in a page order of an original document from the storage device 21 as original document data (step S102).

The original document data is input to the individual processing unit 111. The individual processing unit 111 retrieves print setting information input by a user, and generates print data that are image data of print images of the original document data. In the print setting information, a 2-up page layout processing is defined for printing two A4-size pages on one A4-size print sheet as explained above. Therefore, the individual processing unit 111 retrieves a setting for the 2-up page layout processing and retrieves layout setting information of the setting for the 2-up page layout processing (step S103). Then, the individual processing unit 111 generates print data (PRN data) of an A4-size print image including the two A4-size pages according to the layout setting information (step S104), and outputs the print data to the particular processing unit 111a.

The particular processing unit 111a judges whether or not coordinate data for the same layout setting is stored in the coordinate data storage area 21b by refereeing to the layout setting information of the original document to which the print request was made (step S105). If the coordinate data for the same layout setting is stored (YES in step S105), the particular processing unit 111a extracts the coordinate data (step S106), and then executes a particular processing to the print images of the print data (step S107). On the other hand, if the coordinate data for the same layout setting is not stored (NO in step S105), the particular processing unit 111a controls the coordinate data converter 113 to generate coordinate data that is newly generated for the new layout setting. In the present embodiment, the particular processing unit 111a controls the coordinate data converter 113 to generate revised coordinate data.

The coordinate data converter 113 generate the revised coordinate data in which a size, a shape or a position of barcode area(s) are modified base on the new layout setting information by using coordinate data stored in the coordinate data storage area 21b (step S108). Specifically, the coordinate data converter 113 generates the revised coordinate data D3′ and D4′ by converting coordinate values of coordinate data D3 and D4 for the first and second pages (A4 size) of the original document data according to the layout information for the 2-up page layout.

Note that the coordinate data converter 113 generates the revised coordinate data D3′ and D4′ according to a size, a shape or a position of the reduced barcode area in a case where the reduced barcode has a dimension enough to be scanned correctly, but generates the revised coordinate data D3′ and D4′ based on a size, a shape or a position of a barcode modified so as to be scanned correctly in a case where the reduced barcode doesn't have a dimension enough to be scanned correctly.

In such a case of the 2-up page layout processing to print two A4 size pages on one A4 size print sheet, a dimension of the modified barcode area to be scanned correctly is set to a dimension more than twice the dimension of the reduced barcode area according to a default reduction scale rate for the 2-up page layout. Here, if the reduced barcode area doesn't have a dimension enough to be scanned correctly, the dimension of the barcode area is not reduced and only its coordinate position is modified to generate the revised coordinate data D3′ and D4′.

Then, the coordinate data converter 113 output the revised coordinate data D5 to the particular processing unit 11 a. In addition, the coordinate data converter 113 correlates the revised coordinate data D3′ and D4′ with the layout setting information, and stores it in database of the coordinate data storage area 21b prepared for a 2-up page layout (on a reduced print sheet size).

The particular processing unit 111a retrieves the generated revised coordinate data D3′ and D4′. In addition, the particular processing unit 111a merges the revised coordinate data D3′ and D4′ with the print data (PRN data: A4 size including the 2-up layout), and executes a particular processing to set reduced print concentration to the barcodes in the barcodes areas defined by the revised coordinate data D3′ and D4′ (step S107).

Namely, the particular processing unit 111a modifies a size, a shape or a position of a barcode print image(s) within the barcode area(s) based on the revised coordinate data D3′ and D4′, and also modifies a size, a shape or a position of all images (images A and B) other than the barcode(s) outside the barcode area(s). Then, the print data after the particular processing are output to the inkjet printer 1 via the individual processing unit 111 as a print job adapted to the layout setting information.

(Processes for Generating Coordinate Data having Page Order of Original Document)

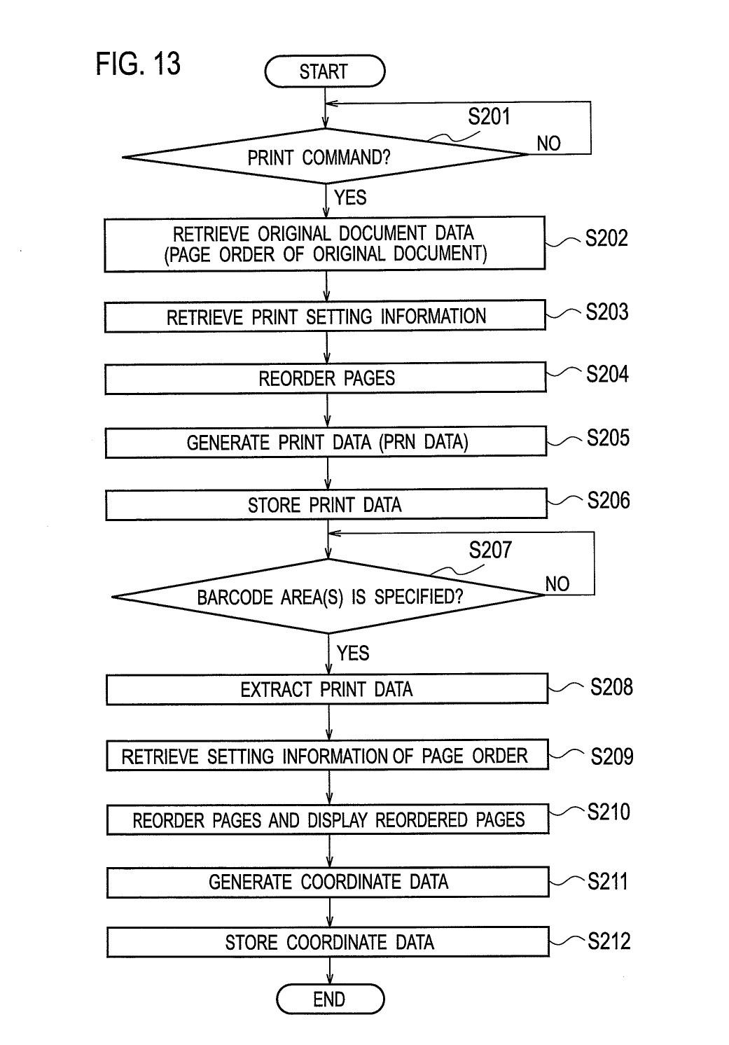

Processes for generating coordinate data (having a page order of an original document) executed by the CPU 16 will be explained with reference to a flowchart shown in FIG. 13. Note that, in the present embodiment, explained will be an exemplary case where a print request for a print data that needs a print job including multiple subsets. A finishing processing is set for each subset in the print job (face-up ejection, face-down ejection, and double-leaved booklet printing).

Firstly, the printer driver 110 judges whether or not a print request for a displayed document is made during an application program is running (step S201). If the print request is not made (NO in step S201), it stands by until the print request is made. If the print request is made (YES in step S201), it retrieves print images ordered in a page order of the original document from the storage device 21 as original document data (step S202).

The original document data is input to the individual processing unit 111. The individual processing unit 111 retrieves print setting information input by a user (step S203), and generates print data that are image data of print images of the original document data. In the print setting information, a finishing processing is defined for each subset in the print job. Here, a subset finishing setting for a face-down ejection is set for the first to third pages. In addition, a subset finishing setting for a face-up ejection is set for the fourth to sixth pages. Further, a subset finishing setting for double leaved booklet printing is set for the seventh to tenth pages.

The individual processing unit 111 retrieves the finishing settings for every subset, and generates order information for each of the finishing settings. The individual processing unit 111 reorders a page order of the original document data (original document page order) to a page order to be printed (print page order) based on the finishing settings (step S204), and generates print data (PRN data) according to the reordered page order (step S205).

Since a face-down ejection is set to the first to third pages of the original document data as a subset finishing processing in the present embodiment, the order information of the print page order for the subset is generated so as to print the first to third pages in an ascend order. Then, the individual processing unit 111 allocates a print image of the first page in the original document data to the first page in the print page data, allocates a print image of the second page in the original document data to the second page in the print page data, and allocates a print image of the third page in the original document data to the third page in the print page data.

In addition, since a face-up ejection is set to the fourth to sixth pages of the original document data as a subset finishing processing, the order information of the print page order for the subset is generated so as to print the fourth to sixth pages in a descend order. Then, the individual processing unit 111 allocates a print image of the fourth page in the original document data to the sixth page in the print page data, allocates a print image of the fifth page in the original document data to the fifth page in the print page data, and allocates a print image of the sixth page in the original document data to the fourth page in the print page data.

Further, since double-leaved booklet printing is set to the seventh to tenth pages of the original document data as a subset finishing processing, the order information of the print page order for the subset is generated so as to exchange the seventh page with the eighth page and also exchange the ninth page with the tenth page. Then, the individual processing unit 111 allocates a print image of the eighth page in the original document data to the seventh page in the print page data, allocates a print image of the seventh page in the original document data to the eighth page in the print page data, allocates a print image of the tenth page in the original document data to the ninth page in the print page data, and allocates a print image of the ninth page in the original document data to the tenth page in the print page data.

Subsequently, the individual processing unit 111 adds the order information to the print data generated with the reordered page order for the first to tenth pages, and then stores the print data in the print data storage area 21 a of the storage device 21.

The printer driver 110 judges whether or not a direction(s) for specifying a barcode area(s) is made (step S207). If the direction for specifying a barcode area is not made (NO in step S207), the printer driver 110 stands by until the direction is made. If the direction for specifying a barcode area is made (YES in step S207), the barcode area specifying application program is executed, and the page reordering unit 121 extracts the print data corresponding to the direction from the print data storage area 21a (step S208).

The page reordering unit 121 refers to the order information from the extracted print data (step S209), and displays the print images in the print data on the edit screen of the output device 20 in the page order of the original document as shown in FIG. 10C (step S210). The barcode area setting unit 122 receives user's operation for specifying a barcode area(s) through the input device 19, and retrieves a coordinate value(s) of the barcode area(s) specified by the user.

The coordinate data setting unit 123 generates the coordinate data of the barcode area(s) to each pages ordered in the page order of the original document as shown in FIG. 10D (step 5211) when a “save” command is input by a user. The coordinate data is stored in the storage area for non-impositioning 211 (step S212).

Note that, in the present embodiment, the coordinate data of the barcode area(s) are stored in the storage device 21 of the client terminal(s) 14. However, the coordinate data of the barcode area(s) may be stored in a storage device of the server 130 on the local area network LAN shown in FIG. 1 together with the printer driver software (and the barcode area specifying application program). According to such a configuration, each of the client terminals 14 on the local area network LAN can share the coordinate data of the barcode area(s) (e.g. newly stored/saved coordinate data), and thereby the data can be utilized effectively and efficiently.

In this configuration, when the CPU 16 runs the printer driver software (and the barcode area specifying application program) to executes the various processings in the present embodiment, the coordinate data of the barcode area(s) are retrieved from the storage device of the server 130, and temporally stored in the storage device 21 or the RAM 18 of each of the client terminals 14. Therefore, a coordinate data storage unit defined in Claims is the storage device 21 or the RAM 18 in this configuration.

Further, in the present embodiment, the inkjet printer 1 is explained as a printer defined in Claims. However, the printer may be one using various printing method other than inkjet printing, such as electrographic printing or stencil printing.

(Advantages)

According to the present embodiment, the coordinate data having the page order of the original document stored in the storage area for non-impositioning 211 are converted to the revised coordinate data in which a size, a shape and a position of barcode area(s) is revised according to the layout setting information. Therefore, the page images can be printed adequately so as to comply with the layout setting information even when a printing processing accompanied by a layout change due to the individual processing (e.g. N-up page layout or the like) is executed with regard to the identical original document data.

In the present embodiment, the coordinate data storage area 21b correlates the revised coordinate data generated by the coordinate data converter 113 with the layout setting information, and stores the revised coordinate data together with the layout setting information. The revised coordinate data correlated with the layout setting information may be deleted upon completion of printing without being stored. However, if the revised coordinate data is stored together with the layout setting information, the revised coordinate data can be utilized when a printing processing with the identical print layout will be executed.

In the present embodiment, the individual processing unit 111 modifies a size, a shape or a position of a print image(s) outside a target area (barcode area) according to a size, a shape or a position of the target area (barcode area). Therefore, the revised coordinate data of the target area can be utilized when a printing processing with the identical print layout will be executed.

In the present embodiment, when a finishing processing includes a process accompanied by a print scale change (e.g. print images are scaled down due to an N-up processing), a size, a shape or a position of a barcode area(s) is firstly determined, and then a size, a shape or a position of print images outside the barcode area(s) is modified according to the determined barcode area(s). Namely, if the barcode area is to be scaled down so as not to have a dimension enough to be scanned correctly, the dimension of the barcode area is not scaled down but maintained. But the print images outside the barcode area are scale-changed so that whole images in a page can be printed on a print sheet. Therefore, the barcode can be scanned correctly, and all the print images included in the original document can be printed on the print sheet.

In the present embodiment, a particular processing for setting lower concentration to a barcode within a barcode area than concentration for other colored solid portions. Therefore, degradation of barcode scanning accuracy due to ink bleed can be prevented, and imaging accuracy of a print image can be ensured.

Note that contents of the coordinate data (CSV data) of a barcode area(s) in a form to be printed on a print sheet may be manually input by a user, and then the input contents may be stored in the storage device 21. However, according to the configuration in the present embodiment (a barcode area(s) is specified on the edit screen displayed on the output device 20 of the client terminal 14, and the coordinate value(s) of the specified barcode area(s) are retrieved as the coordinate data), a coordinate value(s) of a barcode area(s) can be set and retrieved easily and accurately.

The present invention is not limited to the above-mentioned embodiment, and it is possible to embody the present invention by modifying the components in the range that does not depart from the scope thereof. Further, it is possible to form various kinds of inventions by appropriately combining a plurality of components disclosed in the above-mentioned embodiment. For example, it may be possible to omit several components from all of the components shown in the above-mentioned embodiment.

The present application claims the benefit of priority under 35 U.S.C. §119 to Japanese Patent Application No. 2012-41883, filed on Feb. 28, 2012, the entire content of which is incorporated herein by reference.

What is claimed is:

1. A printer control apparatus configured to output a print job generated based on page images of an original document to a printer, the apparatus comprising:
an original document data retriever configured to retrieve the page images ordered in a page order of the original document as original document data;
an individual processing unit configured to retrieve layout setting information that defines a print layout of the page images to be printed on a print sheet by the printer based on an individual processing to be applied to the original document data, and to generate print data in which print images are ordered according to the layout setting information;
a coordinate data storage unit configured to correlate coordinate data of a target area in the page images to be processed by a particular processing with the page order of the original document, and to store the coordinate data for each of the print images;
a coordinate data converter configured to generate revised coordinate data by converting the coordinate data stored in the coordinate data storage unit based on the layout setting information;
a particular processing unit configured to execute the particular processing to the target area based on the revised coordinate data and the print data; and
a print job output unit configured to output the print data processed by the particular processing to the printer as the print job.

2. The printer control apparatus according to claim 1, wherein
the coordinate data storage unit is configured to correlate the revised coordinate data with the layout setting information, and to store the revised coordinate data correlated with the layout setting information.

3. The printer control apparatus according to claim 1, wherein
the coordinate data converter is configured to generate the generate revised coordinate data by modifying a size, a shape or a position of the target area based on the layout setting information, and
the individual processing unit is configured to modify a size, a shape or a position of images outside the target area.

4. The printer control apparatus according to claim 1, wherein
the target area is a barcode area including a barcode, and
the particular processing is a processing for setting lower concentration to the barcode than concentration of other colored solid portions in the page images.
